(19) United States
(12) Patent Application Publication
(10) Pub. No.: US 2025/0323443 A1
(43) Pub. Date: Oct. 16, 2025

(54) SOCKET CONNECTOR

(71) Applicant: Cheng Uei Precision Industry Co., Ltd., New Taipei City (TW)

(72) Inventors: Li Nien Hsu, New Taipei City (TW); Sheng Nan Yu, New Taipei City (TW)

(21) Appl. No.: 18/921,084

(22) Filed: Oct. 21, 2024

(30) Foreign Application Priority Data
Apr. 12, 2024 (CN) 202420762636.9

(51) Int. Cl. H01R 13/42; H01R 12/71; H01R 13/11; H01R 13/502; H01R 24/58; H01R 105/00

(52) U.S. Cl. CPC H01R 13/42; H01R 13/111; H01R 13/502; H01R 24/58; H01R 12/714; H01R 12/716; H01R 2105/00

(57) ABSTRACT

This invention relates to a socket connector includes a shell, a lid, a center terminal, a first terminal and a second terminal. The shell has a first lateral wall, a second lateral wall, a front wall and a rear wall. A front surface of the front wall is recessed inward to form a docking groove. Two outer surfaces of the first lateral wall and the second lateral wall protrude outward to form two lug portions. The lid is covered to a rear surface of the rear wall of the shell. A front end of the center terminal is inserted into the docking groove. The first terminal has an inserting tab. The inserting tab is clipped to the lug portion of the first lateral wall. The second terminal has an inserting unit. The inserting unit is clipped to the lug portion of the second lateral wall.

### CROSS REFERENCE TO RELATED APPLICATIONS

The present application is based on, and claims priority from, China Patent Application No. 202420762636.9, filed Apr. 12, 2024, the disclosure of which is hereby incorporated by reference herein in its entirety.

### BACKGROUND OF THE INVENTION

### Field of the Invention

The present invention generally relates to a socket connector, and more particularly to a socket connector that improves a transmission stability.

### Description of Related Art

Socket connectors are widely used in electronic devices, such as stereos, cellular phones, and laptops, etc. A corresponding plug of an electronic peripheral device is inserted into the socket connector of the electronic device for realizing a purpose of transmitting power or signals mutually.

A power socket connector includes an insulating body, a center terminal and an elastic terminal mounted in the insulating body. One end of the insulating body opens an inserting hole. The other end of the insulating body opens a guiding hole and an opening groove. The inserting hole is communicated with the guiding hole and the opening groove. An inner wall of the guiding hole of the insulating body protrudes inward to form an annular locking portion. Two opposite walls of the opening groove define two buckling slots. The central terminal has a first connecting portion accommodated in the guiding hole. A middle of a peripheral surface of the first connecting portion is recessed inward to form an annular limiting groove. The locking portion of the insulating body is locked in the annular limiting groove of the central terminal to prevent the central terminal receding from the insulating body. The elastic terminal has a second connecting portion accommodated in the opening groove, and a contacting portion curved towards the inserting hole from a free end of the second connecting portion. Two sides of the second connecting portion protrude outward and then extend towards the insulating body to form two buckling pieces. The two buckling pieces are buckled in the two buckling slots. The contacting portion projects into the inserting hole.

However, in the above-mentioned design of the power socket connector, the elastic terminal and the insulating body lack a limiting structure between the elastic terminal and the insulating body, so that when a docking plug is frequently inserted into or withdrawn from the power socket connector, the elastic terminal is easy to be loosened on account of an affection of an inserting force or a withdrawal force, and the elastic terminal is apt to break away from the insulating body. As a result, a signal transmission stability of the power socket connector is affected.

In view of the aforesaid shortcomings, it is necessary to provide a socket connector that improves a transmission stability.

### BRIEF SUMMARY OF THE INVENTION

An object of the present invention is to provide a socket connector that improves a transmission stability. The socket connector includes a shell, a lid, a center terminal, a first terminal and a second terminal. The shell has a first lateral wall, a second lateral wall opposite to the first lateral wall, a front wall, and a rear wall opposite to the front wall. The first lateral wall and the second lateral wall are connected between the front wall and the rear wall. A middle of a front surface of the front wall is recessed inward to form a docking groove. Two outer surfaces of the first lateral wall and the second lateral wall protrude outward to form two lug portions. A junction between the second lateral wall and the rear wall is recessed inward to form a limiting groove. The lid is covered to a rear surface of the rear wall of the shell. A rear surface of the lid is recessed inward to form a restricting groove. A lower portion of one side of the lid protrudes outward to form a restricting unit. A front end of the center terminal is inserted into the docking groove. A rear end of the center terminal is exposed to the restricting groove. The first terminal has an inserting tab extended frontward from a lower portion of a front edge of the first terminal, an elastic conducting portion connected with an upper portion of the front edge of the first terminal, and a retaining groove recessed inward from a rear edge of the first terminal. The inserting tab is clipped to the lug portion of the first lateral wall. The restricting unit is retained in the retaining groove. The elastic conducting portion is received in the shell. The second terminal has an inserting unit extended frontward from an upper portion of a front edge of the second terminal, a limiting block extended inward from an inner surface of the second terminal, and a contacting board perpendicularly bent sideward from a rear of the second terminal. The inserting unit is clipped to the lug portion of the second lateral wall. The limiting block is limited in the limiting groove. The contacting board is inserted in the restricting groove. The contacting board is mounted around the rear end of the center terminal.

Another object of the present invention is to provide a socket connector. The socket connector includes a shell, a lid, a center terminal, a first terminal and a second terminal. The shell has a first lateral wall, a second lateral wall opposite to the first lateral wall, a front wall, and a rear wall opposite to the front wall. The first lateral wall and the second lateral wall are connected between the front wall and the rear wall. A middle of a front surface of the front wall is recessed inward to form a docking groove. Two outer surfaces of the first lateral wall and the second lateral wall protrude outward to form two lug portions. A junction between the second lateral wall and the rear wall is recessed inward to form a limiting groove. The lid is covered to a rear surface of the rear wall of the shell. A rear surface of the lid is recessed inward to form a restricting groove. A lower portion of one side of the lid protrudes outward to form a restricting unit. A front end of the center terminal is inserted into the docking groove. A rear end of the center terminal is exposed to the restricting groove. The first terminal has a first assembling board, an inserting tab extended forward from a middle of a front edge of the first assembling board, a connecting board extended horizontally from a top of the first assembling board, an elastic conducting portion curved rearward, then slantwise extended downward and rearward, and further arched upward from a front end of the connecting board, and a retaining groove recessed inward from a middle of a rear edge of the first assembling board. The inserting tab is clipped to the lug portion of the first lateral wall. The restricting unit is retained in the retaining groove. The elastic conducting portion is received in the shell. The second terminal has a second assembling board, an inserting unit extended frontward from an upper portion of a front edge of the second assembling board, a limiting block extended inward from an inner surface of the second assembling board, a contacting board perpendicularly bent inward from a rear edge of the second assembling board, and a perforation formed in the contacting board. The inserting unit is clipped to the lug portion of the second lateral wall. The limiting block is limited in the limiting groove. The contacting board is inserted in the restricting groove. The rear end of the center terminal is mounted in the perforation. An outer diameter of a tail end of the center terminal is larger than an inside diameter of the perforation. The tail end of the center terminal is exposed out of the perforation, and the tail end of the center terminal is blocked to an outer surface of the contacting board.

Another object of the present invention is to provide a socket connector. The socket connector includes a shell, a lid, a center terminal, a first terminal and a second terminal. The shell has a first lateral wall, a second lateral wall opposite to the first lateral wall, a front wall, and a rear wall opposite to the front wall. The first lateral wall and the second lateral wall are connected between the front wall and the rear wall. A middle of a front surface of the front wall is recessed inward to form a docking groove. A junction between the second lateral wall and the rear wall is recessed inward to form a limiting groove. Two outer surfaces of the first lateral wall and the second lateral wall protrude outward to form two lug portions. A middle of an inner portion of each lug portion defines a through hole longitudinally penetrating through the lug portion. The lid is covered to a rear surface of the rear wall of the shell. A rear surface of the lid is recessed inward to form a restricting groove. A lower portion of one side of the lid protrudes outward to form a restricting unit. A front end of the center terminal is inserted into the docking groove. A rear end of the center terminal is exposed to the restricting groove. The first terminal has a first assembling board, an inserting tab extended forward from a middle of a front edge of the first assembling board, a connecting board extended horizontally from a top of the first assembling board, an elastic conducting portion curved rearward, then slantwise extended downward and rearward, and further arched upward from a front end of the connecting board, and a retaining groove recessed inward from a middle of a rear edge of the first assembling board. The inserting tab is inserted into the through hole of the lug portion of the first lateral wall. The restricting unit is retained in the retaining groove. The elastic conducting portion is received in the shell. The second terminal has a second assembling board, an inserting unit extended frontward from an upper portion of a front edge of the second assembling board, a limiting block extended inward from an inner surface of the second assembling board, a contacting board perpendicularly bent inward from a rear edge of the second assembling board, and a perforation formed in the contacting board. The inserting unit is inserted into the through hole of the lug portion of the second lateral wall. The limiting block is limited in the limiting groove. The contacting board is inserted in the restricting groove. The rear end of the center terminal is mounted in the perforation. An outer diameter of a tail end of the center terminal is larger than an inside diameter of the perforation. The tail end of the center terminal is exposed out of the perforation, and the tail end of the center terminal is blocked to an outer surface of the contacting board.

As described above, the socket connector is disposed on the circuit board for being connected with the plug connector. Furthermore, the inserting tab of the first terminal is inserted into the through hole of the lug portion of the first lateral wall, and a retaining portion is retained in the retaining groove, so that a displacement of the first terminal is limited. In addition, the inserting unit is inserted into the through hole of the lug portion of the second lateral wall, and the limiting block is limited in the limiting groove, so that a displacement of the second terminal is limited. Therefore, the first terminal and the second terminal are fastened to an insulating body stably, so that the socket connector improves a signal transmission stability between the socket connector and the plug connector.

### BRIEF DESCRIPTION OF THE DRAWINGS

The present invention will be apparent to those skilled in the art by reading the following description, with reference to the attached drawings, in which:

FIG. 1 is a perspective view of a socket connector in accordance with a preferred embodiment of the present invention;

FIG. 2 is an exploded view of the socket connector in accordance with the preferred embodiment of the present invention;

FIG. 3 is a cross-sectional view of the socket connector along a line I-I of FIG. 1;

FIG. 4 is an exploded view of an insulating body of the socket connector in accordance with the preferred embodiment of the present invention;

FIG. 5 is another exploded view of the insulating body of the socket connector in accordance with the preferred embodiment of the present invention;

FIG. 6 is a cross-sectional view of the insulating body of the socket connector along a line II-II of FIG. 5;

FIG. 7 is a perspective view of a first terminal of the socket connector in accordance with the preferred embodiment of the present invention;

FIG. 8 is a perspective view of a second terminal of the socket connector in accordance with the preferred embodiment of the present invention; and

FIG. 9 is a perspective view of the socket connector according to another preferred embodiment of the present invention.

### DETAILED DESCRIPTION OF THE INVENTION

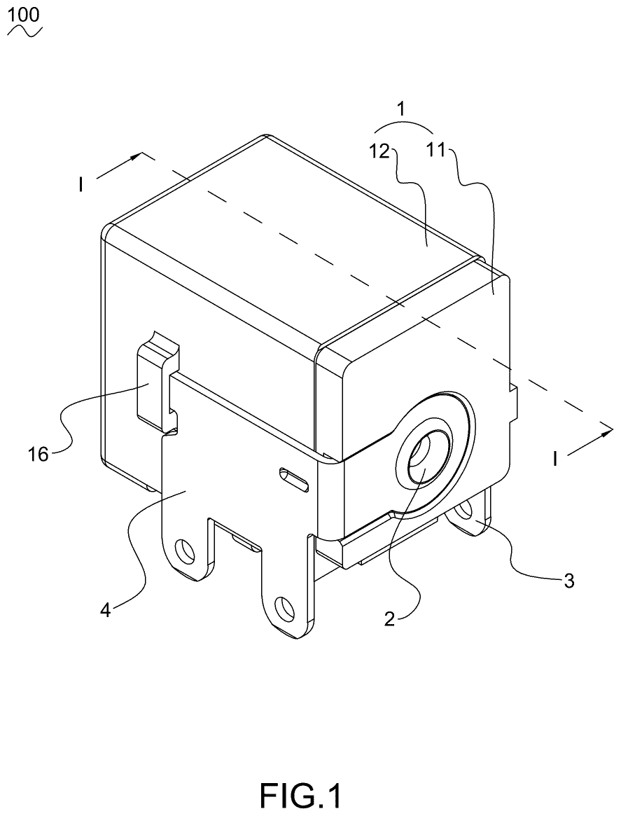

Referring to FIG. 1 to FIG. 3, a socket connector 100 in accordance with a preferred embodiment of the present invention is shown. The socket connector 100 is disposed on a circuit board (not shown) for being connected with a plug connector (not shown). The socket connector 100 includes an insulating body 1, two limiting structures 16 arranged on two outer surfaces of two side walls of the insulating body 1, a center terminal 2 accommodated in the insulating body 1, a first terminal 3 combined with one limiting structure 16 to be assembled to one side wall of the insulating body 1, and a second terminal 4 combined with the other limiting structure 16 to be assembled to the other side wall of the insulating body 1.

A bottom end of the first terminal 3 and a bottom end of the second terminal 4 are fastened to the circuit board (not shown). Then the plug connector is inserted to the center terminal 2 to electrically connect with the first terminal 3 and the second terminal 4, and the first terminal 3 and the second terminal 4 are stably combined with the insulating body 1 by the two limiting structures 16, so that a stable electrical connection between the socket connector 100 and the plug connector is realized.

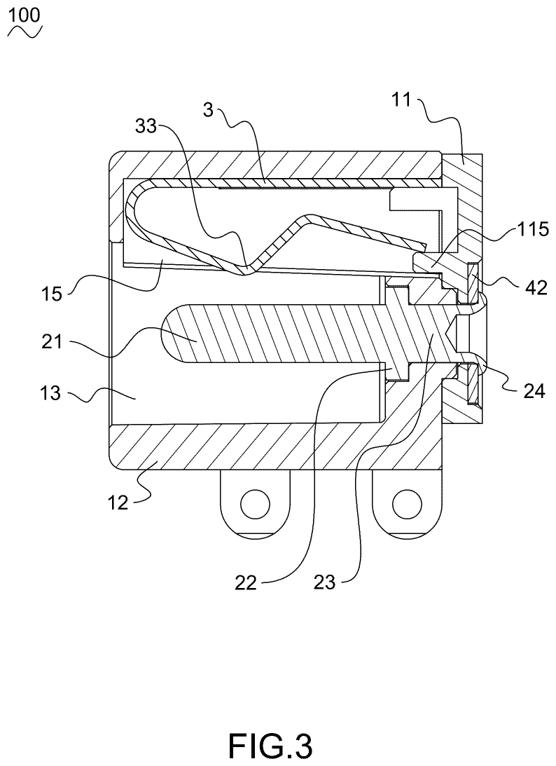

Referring to FIG. 3 to FIG. 6, the insulating body 1 includes a lid 11 and a shell 12. The lid 11 is assembled with the shell 12. The shell 12 is formed in a rectangular shape. The shell 12 has a top wall 12a located at a top of the shell 12, a bottom wall 12b located at a bottom of the shell 12, a first lateral wall 12c located at one side of the shell 12, a second lateral wall 12d opposite to the first lateral wall 12c, a front wall 12e located at a front of the shell 12, and a rear wall 12f opposite to the front wall 12e. The second lateral wall 12d is located at the other side of the shell 12. The rear wall 12f is located at a rear of the shell 12. The first lateral wall 12c and the second lateral wall 12d are connected between the front wall 12e and the rear wall 12f. The first lateral wall 12c is connected between two sides of the front wall 12e and the rear wall 12f. The second lateral wall 12d is connected between the other two sides of the front wall 12e and the rear wall 12f. The top wall 12a is connected with tops of the front wall 12e, the first lateral wall 12c, the second lateral wall 12d and the rear wall 12f, and the bottom wall 12b is connected with bottoms of the front wall 12e, the first lateral wall 12c, the second lateral wall 12d and the rear wall 12f.

A middle of a front surface of the front wall 12e is recessed inward to form a docking groove 13. The docking groove 13 is formed in a cylinder shape for accommodating the center terminal 2. A front end of the center terminal 2 is inserted into the docking groove 13. In order to cover the lid 11 to a rear surface of the rear wall 12f, a middle of the rear surface of the rear wall 12f of the shell 12 protrudes rearward to form a supporting portion 14. The supporting portion 14 is shown as a ring shape. A middle of a front surface of the lid 11 is recessed inward to form a supporting hole 111. The supporting portion 14 is assembled in the supporting hole 111. The supporting portion 14 is buckled in the supporting hole 111, the lid 11 is covered to the rear surface of the rear wall 12f of the shell 12, and the lid 11 is combined with the shell 12.

An upper portion of the rear wall 12f of the shell 12 is recessed inward to form a mounting groove 15. The mounting groove 15 is located above the supporting portion 14. The mounting groove 15 is located to a top of the docking groove 13. The mounting groove 15 is communicated with the docking groove 13. An upper portion of the front surface of the lid 11 protrudes frontward to form a fixing unit 115. The fixing unit 115 is cooperated with the mounting groove 15, the fixing unit 115 is mounted in the mounting groove 15, and the fixing unit 115 is connected to the mounting groove 15. The fixing unit 115 includes an upper fixing unit 1150 located at a top of the fixing unit 115, and a lower fixing unit 1151 located at a bottom of the fixing unit 115.

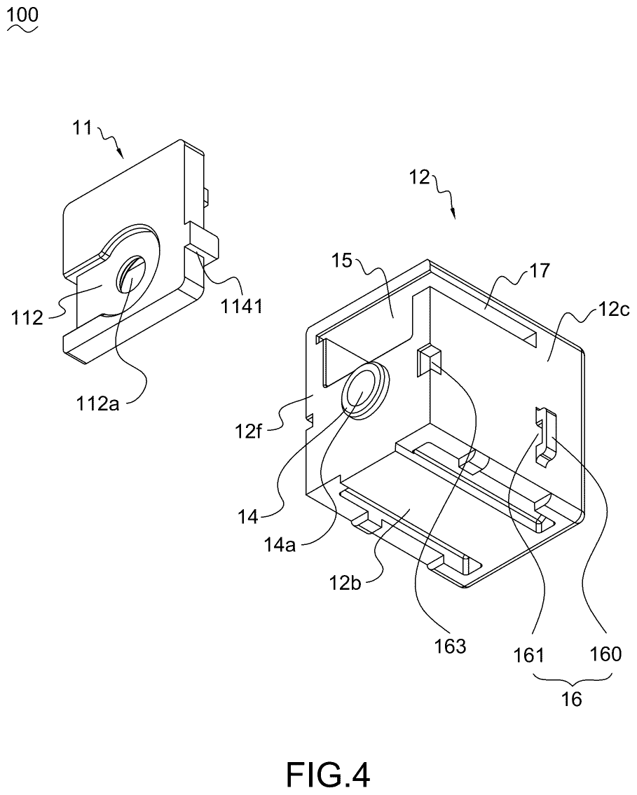

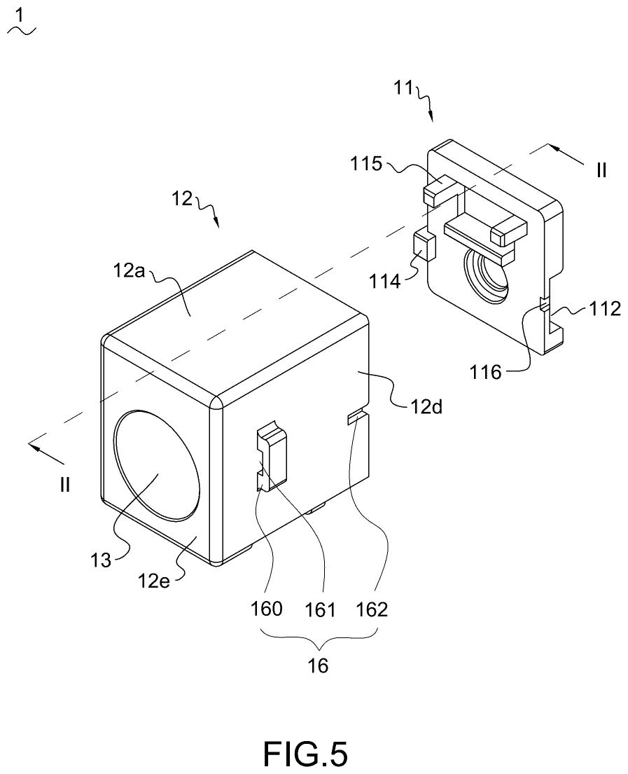

Referring to FIG. 4 and FIG. 5, each limiting structure 16 includes a lug portion 160 and a through hole 161. Two outer surfaces of the first lateral wall 12c and the second lateral wall 12d protrude outward to form two lug portions 160. A middle of an inner portion of each lug portion 160 defines a through hole 161 longitudinally penetrating through the lug portion 160. A middle of a junction between the second lateral wall 12d and the rear wall 12f is recessed inward to form a limiting groove 162. A middle of a junction between the first lateral wall 12c and the rear wall 12f of the shell 12 is recessed inward to form a locating groove 163.

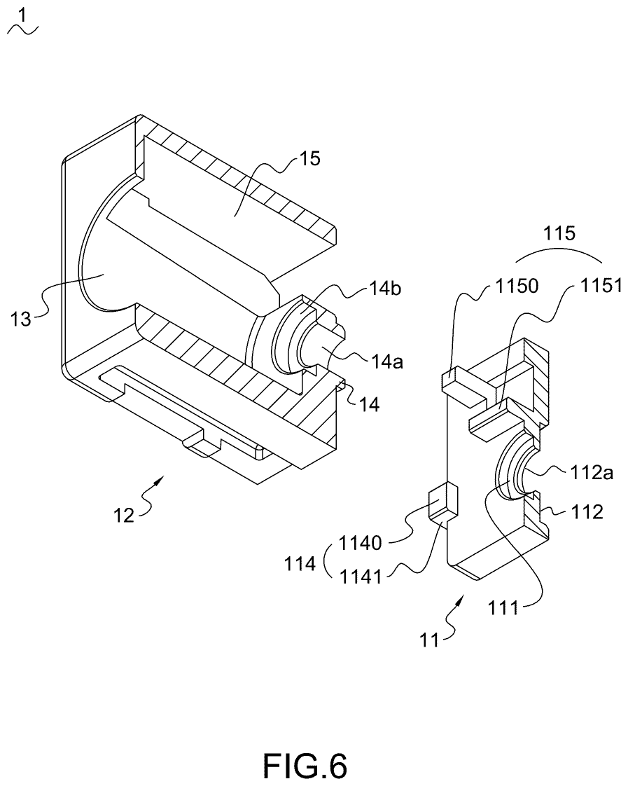

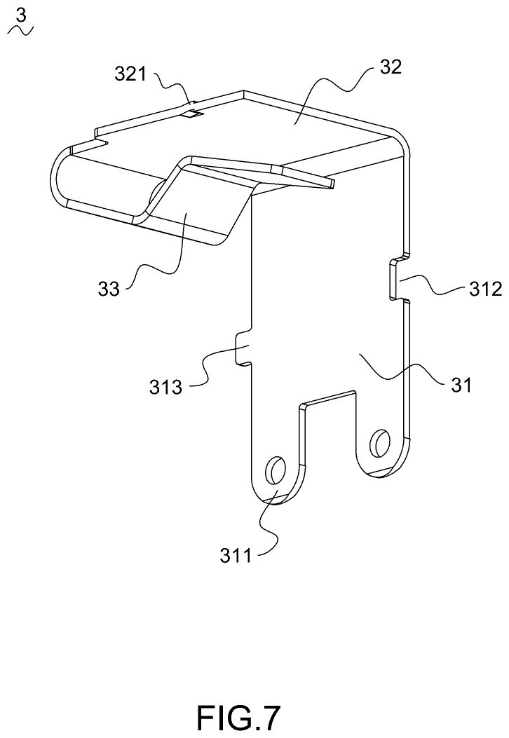

Referring to FIG. 4, FIG. 6 and FIG. 7, an upper portion of the shell 12 defines a holding groove 17 transversely penetrating through the first lateral wall 12c, an inner portion of the second lateral wall 12d, and an upper portion of the rear wall 12f. The holding groove 17 is located to a rear of a top of the mounting groove 15. The holding groove 17 is connected to the top of the mounting groove 15. The holding groove 17 is wider than the mounting groove 15 in width.

The first terminal 3 has an inserting tab 313 extended frontward from a lower portion of a front edge of the first terminal 3, an elastic conducting portion 33 connected with an upper portion of the front edge of the first terminal 3, and a retaining groove 312 recessed inward from a rear edge of the first terminal 3. The first terminal 3 has a first assembling board 31, a first pin 311 extended downward from a bottom of the first assembling board 31, the retaining groove 312 recessed inward from a middle of a rear edge of the first assembling board 31, the inserting tab 313 extended forward from a middle of a front edge of the first assembling board 31, a connecting board 32 extended horizontally from a top of the first assembling board 31, a bump 321 protruded upward from a top surface of one side of the connecting board 32, and the elastic conducting portion 33 curved rearward, then slantwise extended downward and rearward, and further arched upward from a front end of the connecting board 32. In the preferred embodiment, the first terminal 3 has two first pins 311 extended downward from a front and a rear of the bottom of the first assembling board 31.

In order to fasten the first terminal 3 to the insulating body 1 stably, the first assembling board 31 is affixed to the outer surface of the first lateral wall 12c. The inserting tab 313 of the first terminal 3 is inserted into the through hole 161 of the lug portion 160 of the limiting structure 16 of the first lateral wall 12c, so the inserting tab 313 is clipped to the lug portion 160 of the first lateral wall 12c, and the inserting tab 313 of the first terminal 3 is combined with the lug portion 160 of the limiting structure 16 of the first lateral wall 12c. The retaining groove 312 is aligned with the locating groove 163. The elastic conducting portion 33 is received in the shell 12.

A lower portion of one side of the lid 11 protrudes outward to form a restricting unit 114. The restricting unit 114 includes a locating portion 1140 protruded frontward from the front surface of the lid 11, and a retaining portion 1141 protruded outward from a lower portion of one side surface of the lid 11. The locating portion 1140 is located in the locating groove 163, and the retaining portion 1141 of the restricting unit 114 is retained in the retaining groove 312, so that movements of the first terminal 3 in up and down directions are limited, and movements of the first terminal 3 in front and rear directions are limited. The connecting board 32 is accommodated in the holding groove 17 of the shell 12. The bump 321 abuts against a rear of an inner surface of an upper wall of the holding groove 17. The elastic conducting portion 33 is accommodated in the mounting groove 15 to be electrically connected to the plug connector.

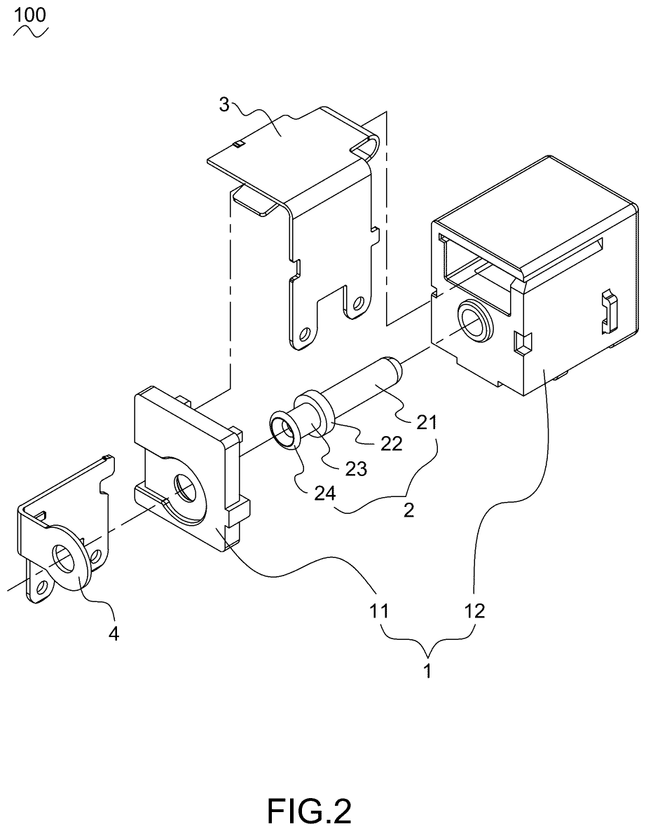

Referring to FIG. 2 to FIG. 8, a rear surface of the lid 11 is recessed inward to form a restricting groove 112. An inner wall of the restricting groove 112 defines a penetrating hole 112a. The penetrating hole 112a is aligned with a middle of the supporting hole 111. The penetrating hole 112a is communicated with the supporting hole 111. An inside diameter of the penetrating hole 112a is smaller than an inside diameter of the supporting hole 111. A lower portion of one side surface of the lid 11 is recessed inward to form a guiding groove 116. The guiding groove 116 is aligned with the limiting groove 162, and the guiding groove 116 is communicated with the limiting groove 162. The guiding groove 116 is connected rearward to the restricting groove 112.

The second terminal 4 has an inserting unit 412 extended frontward from an upper portion of a front edge of the second terminal 4, a limiting block 414 extended inward from an inner surface of the second terminal 4, and a contacting board 42 perpendicularly bent sideward from a rear of the second terminal 4. The second terminal 4 has a second assembling board 41, a second pin 411 extended downward from a bottom edge of the second assembling board 41, the inserting unit 412 extended frontward from an upper portion of a front edge of the second assembling board 41, a barb 413 protruded upward from an upper edge of the inserting unit 412, the limiting block 414 extended inward from an inner surface of the second assembling board 41, the contacting board 42 perpendicularly bent inward from a rear edge of the second assembling board 41, and a perforation 421 formed in the contacting board 42. The perforation 421 is aligned with the penetrating hole 112a. In the preferred embodiment, the second terminal 4 has two second pins 411 extended downward from a front and a rear of the bottom edge of the second assembling board 41.

In order to combine the second terminal 4 with the insulating body 1 stably, the second assembling board 41 is attached to the second lateral wall 12d, the limiting block 414 is limited in the limiting groove 162. The inserting unit 412 is clipped to the lug portion 160 of the second lateral wall 12d. The inserting unit 412 is inserted into the through hole 161 of the lug portion 160 of the second lateral wall 12d, and the barb 413 is interfered with an upper inner wall of the lug portion 160 of the second lateral wall 12d to prevent the second terminal 4 from generating unexpected movements. In this preferred embodiment, the contacting board 42 is inserted in the restricting groove 112, a rear end of the center terminal 2 is exposed to the restricting groove 112, the rear end of the center terminal 2 is mounted in the perforation 421, the contacting board 42 is mounted around the rear end of the center terminal 2, an outer diameter of a tail end of the center terminal 2 is larger than an inside diameter of the perforation 421, the tail end of the center terminal 2 is exposed out of the perforation 421, and the tail end of the center terminal 2 is blocked to an outer surface of the contacting board 42 to make that the second terminal 4 and the center terminal 2 are electrically conductive.

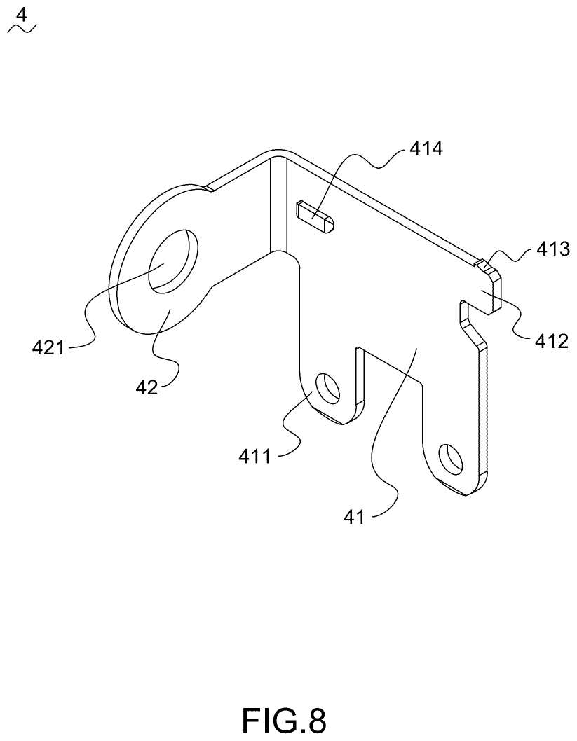

Referring to FIG. 7 and FIG. 8, in the preferred embodiment, the first pin 311 and the second pin 411 are both vertical pins extending downward. The first pin 311 and the second pin 411 are inserted to the circuit board. The first pin 311 and the second pin 411 are fastened to the circuit board in a dual inline package (DIP) way, and the first pin 311 and the second pin 411 are soldered to the circuit board.

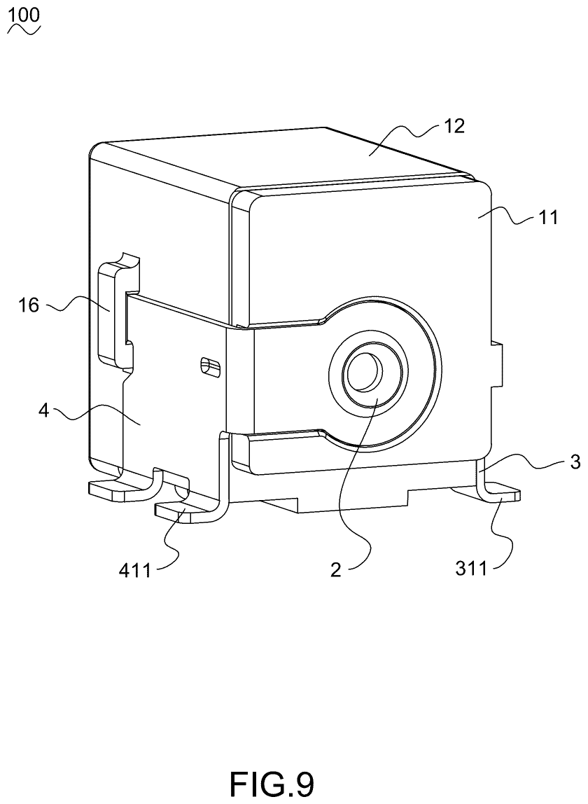

Referring to FIG. 9, in another preferred embodiment, the first pin 311 and the second pin 411 are horizontal pins extending outward and sideward. The first pin 311 and the second pin 411 are fastened to the circuit board, and the first pin 311 and the second pin 411 are soldered to the circuit board in a surface mounting technology (SMT).

Referring to FIG. 2 to FIG. 6, an inside of the supporting portion 14 defines an opening hole 14a penetrating through a rear surface of the supporting portion 14. The opening hole 14a is communicated with the docking groove 13. An inside diameter of the docking groove 13 is larger than an inside diameter of the opening hole 14a. The opening hole 14a is corresponding to the penetrating hole 112a. The opening hole 14a is aligned to the penetrating hole 112a. A front end of the opening hole 14a is adjacent to the docking groove 13. The front end of the opening hole 14a extends frontward and expands outward to form a fixing hole 14b. An inside diameter of the fixing hole 14b is smaller than the inside diameter of the docking groove 13. In order to fasten the center terminal 2, the center terminal 2 has a docking portion 21 for being connected with the plug connector, a fastening portion 22 radially expanded outward from a rear end of the docking portion 21, a connecting portion 23 connected to a rear end of the fastening portion 22, and a blocking portion 24 extended along a radial direction from a rear end of the connecting portion 23.

The blocking portion 24 is elastic, and the blocking portion 24 is deformed when the blocking portion 24 is compressed. The docking portion 21 is inserted into the docking groove 13. The docking portion 21 is received in the docking groove 13. An outer diameter of the fastening portion 22 is larger than an outer diameter of the docking portion 21 and an outer diameter of the connecting portion 23. The fastening portion 22 is fixed in the fixing hole 14b, and the fastening portion 22 is blocked by a front surface of a peripheral wall of the opening hole 14a. The connecting portion 23 is placed in the opening hole 14a, and the connecting portion 23 passes through the penetrating hole 112a and the perforation 421. An outer diameter of the blocking portion 24 is larger than the inside diameter of the perforation 421, so that the blocking portion 24 blocks the outer surface of the contacting board 42 so as to avoid generating an axial displacement of the center terminal 2 in the insulating body 1.

When the socket connector 100 is assembled, specific steps of assembling the socket connector 100 are described as follows. Insert the center terminal 2 into the docking groove 13 via a front end of the docking groove 13 of the front wall 12e of the shell 12. Insert the first terminal 3 into the mounting groove 15 via a rear end of the mounting groove 15 of the rear wall 12f of the shell 12. Assemble the lid 11 to the rear wall 12f of the shell 12, and assemble the second terminal 4 to the shell 12 and the lid 11. The limiting block 414 is limited in the limiting groove 162 through the guiding groove 116. A rear end of the connecting board 32 of the first terminal 3 is clamped between the upper fixing unit 1150 and the upper wall of the holding groove 17. A rear end of the elastic conducting portion 33 of the first terminal 3 abuts against an upper surface of the lower fixing unit 1151.

As described above, the socket connector 100 is disposed on the circuit board for being connected with the plug connector. Furthermore, the inserting tab 313 of the first terminal 3 is inserted into the through hole 161 of the lug portion 160 of the first lateral wall 12c, and the retaining portion 1141 is retained in the retaining groove 312, so that a displacement of the first terminal 3 is limited. In addition, the inserting unit 412 is inserted into the through hole 161 of the lug portion 160 of the second lateral wall 12d, and the limiting block 414 is limited in the limiting groove 162, so that a displacement of the second terminal 4 is limited. Therefore, the first terminal 3 and the second terminal 4 are fastened to the insulating body 1 stably, so that the socket connector 100 improves a signal transmission stability between the socket connector 100 and the plug connector.

What is claimed is:

1. A socket connector, comprising:
a shell having a first lateral wall, a second lateral wall opposite to the first lateral wall, a front wall, and a rear wall opposite to the front wall, the first lateral wall and the second lateral wall being connected between the front wall and the rear wall, a middle of a front surface of the front wall being recessed inward to form a docking groove, two outer surfaces of the first lateral wall and the second lateral wall protruding outward to form two lug portions, a junction between the second lateral wall and the rear wall being recessed inward to form a limiting groove;
a lid covered to a rear surface of the rear wall of the shell, a rear surface of the lid being recessed inward to form a restricting groove, a lower portion of one side of the lid protruding outward to form a restricting unit;
a center terminal, a front end of the center terminal being inserted into the docking groove, a rear end of the center terminal being exposed to the restricting groove;
a first terminal having an inserting tab extended frontward from a lower portion of a front edge of the first terminal, an elastic conducting portion connected with an upper portion of the front edge of the first terminal, and a retaining groove recessed inward from a rear edge of the first terminal, the inserting tab being clipped to the lug portion of the first lateral wall, the restricting unit being retained in the retaining groove, the elastic conducting portion being received in the shell; and
a second terminal having an inserting unit extended frontward from an upper portion of a front edge of the second terminal, a limiting block extended inward from an inner surface of the second terminal, and a contacting board perpendicularly bent sideward from a rear of the second terminal, the inserting unit being clipped to the lug portion of the second lateral wall, the limiting block being limited in the limiting groove, the contacting board being inserted in the restricting groove, the contacting board being mounted around the rear end of the center terminal.

2. The socket connector as claimed in claim 1, wherein a middle of a junction between the first lateral wall and the rear wall of the shell is recessed inward to form a locating groove, the restricting unit includes a locating portion protruded frontward from a front surface of the lid, and a retaining portion protruded outward from a lower portion of one side surface of the lid, the locating portion is located in the locating groove, and the retaining portion is retained in the retaining groove, the retaining groove is aligned with the locating groove.

3. The socket connector as claimed in claim 2, wherein the first terminal has a first assembling board, a first pin extended downward from a bottom of the first assembling board, the retaining groove recessed inward from a middle of a rear edge of the first assembling board, the inserting tab extended forward from a middle of a front edge of the first assembling board, a connecting board extended horizontally from a top of the first assembling board, a bump protruded upward from a top surface of one side of the connecting board, and the elastic conducting portion curved rearward, then slantwise extended downward and rearward, and further arched upward from a front end of the connecting board, the first assembling board is affixed to the outer surface of the first lateral wall, an upper portion of the shell defines a holding groove transversely penetrating through the first lateral wall, an inner portion of the second lateral wall and an upper portion of the rear wall, the connecting board is accommodated in the holding groove, the bump abuts against a rear of an inner surface of an upper wall of the holding groove.

4. The socket connector as claimed in claim 3, wherein the second terminal has a second assembling board, a second pin extended downward from a bottom edge of the second assembling board, the inserting unit extended frontward from an upper portion of a front edge of the second assembling board, a barb protruded upward from an upper edge of the inserting unit, the limiting block extended inward from an inner surface of the second assembling board, and the contacting board perpendicularly bent inward from a rear edge of the second assembling board, the second assembling board is attached to the second lateral wall.

5. The socket connector as claimed in claim 3, wherein an upper portion of the rear wall of the shell is recessed inward to form a mounting groove, the mounting groove is communicated with the docking groove, an upper portion of the front surface of the lid protrudes frontward to form a fixing unit, the fixing unit is mounted in the mounting groove, the holding groove is connected to a top of the mounting groove, the holding groove is wider than the mounting groove in width, the elastic conducting portion is accommodated in the mounting groove.

6. The socket connector as claimed in claim 5, wherein the fixing unit includes an upper fixing unit and a lower fixing unit, a rear end of the connecting board of the first terminal is clamped between the upper fixing unit and the upper wall of the holding groove, a rear end of the elastic conducting portion of the first terminal abuts against an upper surface of the lower fixing unit.

7. The socket connector as claimed in claim 1, wherein a middle of a rear surface of the rear wall of the shell protrudes rearward to form a supporting portion, a middle of a front surface of the lid is recessed inward to form a supporting hole, the supporting portion is buckled in the supporting hole, an inside of the supporting portion defines an opening hole penetrating through a rear surface of the supporting portion, the opening hole is communicated with the docking groove, an inside diameter of the docking groove is larger than an inside diameter of the opening hole, a front end of the opening hole is adjacent to the docking groove, the front end of the opening hole extends frontward and expands outward to form a fixing hole, an inside diameter of the fixing hole is smaller than the inside diameter of the docking groove, an inner wall of the restricting groove defines a penetrating hole, the penetrating hole is aligned with the supporting hole, the penetrating hole is communicated with a middle of the supporting hole, an inside diameter of the penetrating hole is smaller than an inside diameter of the supporting hole, the second terminal has a perforation formed in the contacting board, the perforation is aligned with the penetrating hole.

8. The socket connector as claimed in claim 7, wherein the center terminal has a docking portion, a fastening portion radially expanded outward from a rear end of the docking portion, a connecting portion connected to a rear end of the fastening portion, and a blocking portion extended along a radial direction from a rear end of the connecting portion, the docking portion is received in the docking groove, the fastening portion is fixed in the fixing hole, and the fastening portion is blocked by a front surface of a peripheral wall of the opening hole, an outer diameter of the fastening portion is larger than an outer diameter of the docking portion and an outer diameter of the connecting portion, the connecting portion is placed in the opening hole, and the connecting portion passes through the penetrating hole and the perforation, an outer diameter of the blocking portion is larger than an inside diameter of the perforation, so that the blocking portion blocks an outer surface of the contacting board.

9. The socket connector as claimed in claim 1, wherein a lower portion of one side surface of the lid is recessed inward to form a guiding groove, the guiding groove is aligned with the limiting groove, and the guiding groove is communicated with the limiting groove.

10. The socket connector as claimed in claim 1, wherein a middle of an inner portion of each lug portion defines a through hole longitudinally penetrating through the lug portion, the inserting tab of the first terminal is inserted into the through hole of the lug portion of the first lateral wall.

11. The socket connector as claimed in claim 1, wherein a middle of an inner portion of each lug portion defines a through hole longitudinally penetrating through the lug portion, the second terminal has a barb protruded upward from an upper edge of the inserting unit, the inserting unit is inserted into the through hole of the lug portion of the second lateral wall, and the barb is interfered with an upper inner wall of the lug portion of the second lateral wall.

12. The socket connector as claimed in claim 1, further comprising an insulating body, the insulating body including the lid and the shell, the lid being assembled with the shell.

13. A socket connector, comprising:
a shell having a first lateral wall, a second lateral wall opposite to the first lateral wall, a front wall, and a rear wall opposite to the front wall, the first lateral wall and the second lateral wall being connected between the front wall and the rear wall, a middle of a front surface of the front wall being recessed inward to form a docking groove, two outer surfaces of the first lateral wall and the second lateral wall protruding outward to form two lug portions, a junction between the second lateral wall and the rear wall being recessed inward to form a limiting groove;
a lid covered to a rear surface of the rear wall of the shell, a rear surface of the lid being recessed inward to form a restricting groove, a lower portion of one side of the lid protruding outward to form a restricting unit;
a center terminal, a front end of the center terminal being inserted into the docking groove, a rear end of the center terminal being exposed to the restricting groove;
a first terminal having a first assembling board, an inserting tab extended forward from a middle of a front edge of the first assembling board, a connecting board extended horizontally from a top of the first assembling board, an elastic conducting portion curved rearward, then slantwise extended downward and rearward, and further arched upward from a front end of the connecting board, and a retaining groove recessed inward from a middle of a rear edge of the first assembling board, the inserting tab being clipped to the lug portion of the first lateral wall, the restricting unit being retained in the retaining groove, the elastic conducting portion being received in the shell; and
a second terminal having a second assembling board, an inserting unit extended frontward from an upper portion of a front edge of the second assembling board, a limiting block extended inward from an inner surface of the second assembling board, a contacting board perpendicularly bent inward from a rear edge of the second assembling board, and a perforation formed in the contacting board, the inserting unit being clipped to the lug portion of the second lateral wall, the limiting block being limited in the limiting groove, the contacting board being inserted in the restricting groove, the rear end of the center terminal being mounted in the perforation, an outer diameter of a tail end of the center terminal being larger than an inside diameter of the perforation, the tail end of the center terminal being exposed out of the perforation, and the tail end of the center terminal being blocked to an outer surface of the contacting board.

14. A socket connector, comprising:
a shell having a first lateral wall, a second lateral wall opposite to the first lateral wall, a front wall, and a rear wall opposite to the front wall, the first lateral wall and the second lateral wall being connected between the front wall and the rear wall, a middle of a front surface of the front wall being recessed inward to form a docking groove, a junction between the second lateral wall and the rear wall being recessed inward to form a limiting groove, two outer surfaces of the first lateral wall and the second lateral wall protruding outward to form two lug portions, a middle of an inner portion of each lug portion defining a through hole longitudinally penetrating through the lug portion;
a lid covered to a rear surface of the rear wall of the shell, a rear surface of the lid being recessed inward to form a restricting groove, a lower portion of one side of the lid protruding outward to form a restricting unit;
a center terminal, a front end of the center terminal being inserted into the docking groove, a rear end of the center terminal being exposed to the restricting groove;
a first terminal having a first assembling board, an inserting tab extended forward from a middle of a front edge of the first assembling board, a connecting board extended horizontally from a top of the first assembling board, an elastic conducting portion curved rearward, then slantwise extended downward and rearward, and further arched upward from a front end of the connecting board, and a retaining groove recessed inward from a middle of a rear edge of the first assembling board, the inserting tab being inserted into the through hole of the lug portion of the first lateral wall, the restricting unit being retained in the retaining groove, the elastic conducting portion being received in the shell; and
a second terminal having a second assembling board, an inserting unit extended frontward from an upper portion of a front edge of the second assembling board, a limiting block extended inward from an inner surface of the second assembling board, a contacting board perpendicularly bent inward from a rear edge of the second assembling board, and a perforation formed in the contacting board, the inserting unit being inserted into the through hole of the lug portion of the second lateral wall, the limiting block being limited in the limiting groove, the contacting board being inserted in the restricting groove, the rear end of the center terminal being mounted in the perforation, an outer diameter of a tail end of the center terminal being larger than an inside diameter of the perforation, the tail end of the center terminal being exposed out of the perforation, and the tail end of the center terminal being blocked to an outer surface of the contacting board.
